(19) United States
(12) Patent Application Publication
(10) Pub. No.: US 2005/0066335 A1
(43) Pub. Date: Mar. 24, 2005

(54) System and method for exposing local clipboard functionality towards external applications

(76) Inventor: Robert Aarts, Espoo (FI)

Correspondence Address: Crawford Maunu PLLC, Suite 390, 1270 Northland Drive, St. Paul, MN, 55120, US

(21) Appl. No.: 10/668,676

(22) Filed: Sep. 23, 2003

(51) Int. Cl. G06F 9/00

(52) U.S. Cl. 719/316

(57) ABSTRACT

A system, apparatus and method for allowing external applications to post information to, and/or retrieve information from, a local clipboard associated with another device that is exposed as a service towards the external applications. The local clipboard of a computing device is exposed towards external applications as a service. A request is received from the external application indicating that a transfer of information between the exposed local clipboard of the computing device and the external application is requested. The information is transferred between the local clipboard of the computing device and the external application in response to the request.

### FIELD OF THE INVENTION

This invention relates in general to data communication, and more particularly to a system and method for exposing local clipboard functionality towards external applications over a network.

### BACKGROUND OF THE INVENTION

Computing devices have traditionally provided a temporary memory area referred to as a “clipboard.” Generally, a clipboard refers to a temporary area of memory that is used to transfer data between applications or documents. Nearly all personal computing devices, including handheld and mobile devices, include such a facility. This facility typically allows information to be copied from one local application into another local application by the familiar “cut/copy” and “paste” commands. A “cut” or “copy” command places selected information from one application on the clipboard, where this information can then later be copied from the clipboard and “pasted” into the same or different application. Generally only applications that execute locally on the device can add, copy or remove items to/from the clipboard.

In the modem networking era, devices can communicate over networks in a variety of ways, including voice connections; content browsing, messaging such as e-mail, Short Messaging Service (SMS), or Multimedia Messaging Service (MMS), and so forth. However, such communications often require that a connection be established between the communicating devices, and often need to share identifiers for the users. It would be desirable to exchange information, such as clipboard information, without the need to establish such connections.

U.S. Pat. No. 5,964,834 is directed to a system and method for sharing clipboard information by transferring information from one clipboard to other clipboards. This, however, requires user to define which computers will be participating in the shared clipboard, and requires monitoring for changes on all local clipboards and updating local clipboards with any changes. Computers not specifically designated for participation by the person will not be allowed to use the clipboard. These and various other limitations of such a sharing methodology fail to account for today's vast mobile and landline networking infrastructure.

Network services available to the masses are becoming increasingly prolific, and there is a need to allow service providers and users with a means to share information without the need to communicate such information more formally, such as via e-mail, Short Message Service (SMS), Multimedia Messaging Service (MMS), etc. Currently, there is no well-established method that allows, for example, external applications to copy information to/from a local clipboard on another device. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses a system, apparatus and method for allowing external applications to post information to, and/or retrieve information from, a local clipboard associated with a different device that is exposed as a service towards such external applications.

In accordance with one embodiment of the invention, a method is provided for communicating information over a network. The method includes exposing a local clipboard of a computing device as a service to at least one external application over the network. A transfer indication is received from the external application indicating that a transfer of information between the exposed local clipboard of the computing device and the external application is requested. The information is transferred between the local clipboard of the computing device and the external application in response to the transfer indication.

According to more particular embodiments of such a method, exposing the local clipboard of the computing device as a service involves exposing the local clipboard as a web service to the external applications over the network. Receiving a transfer indication involves receiving a request to copy information from the local clipboard to the external application in one embodiment, and involves receiving a request to copy information from the external application to the local clipboard of the computing device in another embodiment. In another particular embodiment, receiving a transfer indication involves recognizing selection of a link presented to a browser application executing on a device associated with the external application, and receiving the transfer indication associated with the selected link. Other particular embodiments include providing a notification to the external application that information was posted to the local clipboard by the computing device, where providing such a notification may involve sending a message to the external application indicating that the information was posted to the local clipboard by the computing device, or presenting information on a network site available to the external application indicating that the information was posted to the local clipboard by the computing device, or the like.

In accordance with another embodiment of the invention, a method is provided for transferring data between first and second devices over a network. The method includes exposing a local clipboard of the first device as a clipboard web service to an external application(s) operating on the second device, notifying the external application of the availability of the clipboard web service, accepting service requests from the external application via the clipboard web service to access the local clipboard of the first device, and transferring the data in accordance with the service request between the local clipboard and the external application via the clipboard web service.

According to another embodiment of the invention, a network entity is provided that is operable on a network, and that includes a local clipboard for storing data. The network entity includes a clipboard service exposing module for exposing the local clipboard as a service towards external applications having access to the network entity via the network. A service request processing module is coupled to the clipboard service exposing module to receive service requests provided by the external applications. A transceiver is provided to transfer the data between the local clipboard and the external applications as directed by the service requests.

In accordance with another embodiment of the invention, a computing device is provided, where the computing device is operable on a network and includes a local clipboard for storing data. The computing device includes a processor configured to expose the local clipboard as a service towards external applications having access to the computing device via the network, and to receive service requests provided by the external applications. A transceiver is provided for transferring the data between the local clipboard and the external applications as directed by the service requests.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating a representative network environment employing clipboard services in accordance with one embodiment of the invention;

FIG. 2 is a block diagram illustrating a more particular embodiment of a local clipboard service in accordance with the present invention;

FIG. 3 is a flow diagram generally illustrating a manner of communicating information over a network in accordance with one embodiment of the invention;

FIG. 4 is a block diagram of an implementation of a clipboard service according to one embodiment of the present invention, where the clipboard service is implemented as a web service;

FIGS. 5 and 6 illustrate representative use examples in which the principles of the present invention may be employed;

FIG. 7 is a flow diagram illustrating various embodiments of a manner for transferring data between first and second devices, where the clipboard service is implemented as a web service; and

FIG. 8 is a block diagram of a representative computing architecture capable of carrying out operations in accordance with the invention.

### DETAILED DESCRIPTION OF THE INVENTION

In the following description, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a system, apparatus, and method for allowing external applications to post information to, and/or retrieve information from, a local clipboard associated with another device. In accordance with the invention, the local clipboard functionality of a device is exposed as a service to applications that execute on other devices that can establish a connection to the exposed clipboard hosting service. The external applications can then perform at least standard functions such as “copy” and/or “paste” functions to/from the clipboard associated with the clipboard service, providing a variety of uses and benefits as described more fully below.

The clipboard service in accordance with the present invention provides an elegant manner for enabling convenient data transfer from one external application to another, without the need for the external applications to establish a connection to each other, and without such applications having to share an identifier for the user. The external applications need not even be aware of each other. A clipboard service in accordance with the invention also eases user interface (UI) activity, as information stored via the clipboard service can be pasted into electronic forms, databases, and other electronic fields that can otherwise be a tedious endeavor. The possibility of introducing errors is also greatly mitigated through pasting temporarily stored information versus manually entering such information. Further, an advantage of the local service is that information can also be transferred between local applications and external applications. Another advantage of the local clipboard service is that a local service has excellent possibilities to interact with the user to decide on access of external applications to the information, which may potentially be sensitive. This can greatly enhance the effective privacy of the user compared to a server-based clipboard. Many other benefits and advantages of a local clipboard service in accordance with the invention are described in greater detail below, and may otherwise be discerned by those skilled in the art from the description provided herein.

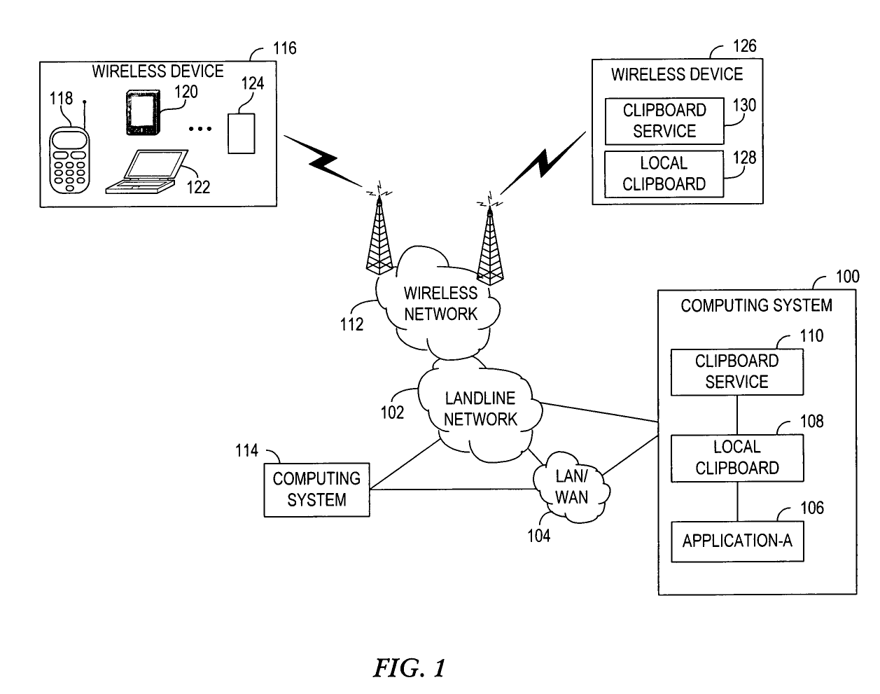

FIG. 1 is a block diagram illustrating a representative network environment employing clipboard services in accordance with one embodiment of the invention. Various types of devices may implement a clipboard service in accordance with the present invention. Such devices include devices operable on a network that include local clipboard functionality. For example, the computing system 100 may represent a desktop computer, workstation, large or mid-scale computing system, portable computer, or any other computing system that can communicate at least by way of a landline network 102 or local network 104. More particularly, such a computing system 100 may be directly coupled to a landline network 102 such as the Internet, or may be coupled to a Local Area Network (LAN), Wireless Access Network (WAN), or other local network which may in turn be coupled to a wider area network such as depicted by the landline network 102. The computing system may implement one or more applications 106 that can post information to and/or retrieve information from a local clipboard 108. In accordance with the present invention, a clipboard service 110 exposes the local clipboard 108 functionality to other applications associated with other devices. Thus, while the local clipboard 108 may be used in a traditional fashion for applications or programs operating at the computing system 100, it may also be used by other applications operating on other devices capable of connecting to the computing system 100 via one or more networks, such as the illustrated networks 102, 104, 112.

In the illustrated embodiment, other systems 114 coupled to the landline network 102 and/or any local area network 104 may post information to, or retrieve information from, the local clipboard 108 of the computing system 100 via the clipboard service 110. Analogously, systems and devices 116 may communicate over-the-air (OTA) to one or more wireless networks 112 which may in turn communicate with landline networks 102, local area networks 104, or other networks. For example, a wireless device 116 may represent a mobile phone 118, Personal Digital Assistant (PDA) 120, portable computing device 122, or other device 124 capable of OTA communication.

Applications operating on any such wireless device 116 or computing system 114 can utilize the local clipboard 108 of the computing system 100 via the clipboard service 110. The clipboard service 110 exposes the local clipboard 108 to such devices 114, 116 over the particular network(s) by which such devices 114, 116 can communicate with the clipboard service 110. Access to the exposed local clipboard 108 by an application(s) operating on any of the networked devices 114, 116 is enabled, which ultimately allows information to be transferred between the local clipboard 108 and the application(s) operating on the networked devices 114, 116.

The present invention is applicable to any device operable on the network and having a local clipboard functionality. For example, a wireless device 126 having a local clipboard 128 may implement a clipboard service 130 in accordance with the invention. The clipboard service 130 may reside at the device 126, or may otherwise be accessible to the device 126 such as via a standalone clipboard service physically separate from, but capable of communication with, the device 126. In this manner, any networked device can expose its local clipboard functionality as a service for use with other networked devices.

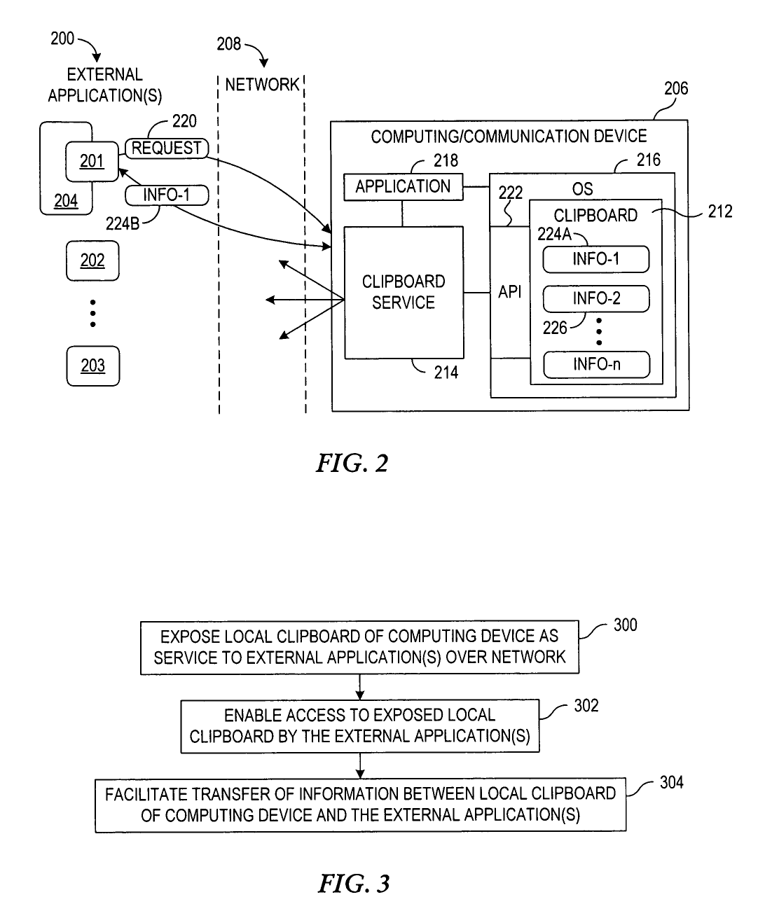

FIG. 2 is a block diagram illustrating a more particular embodiment of a local clipboard service in accordance with the present invention. In the illustrated embodiment, one or more external applications 200 may communicate with the communication device 206 over one or more interconnected networks 208. The external applications 200, including representative applications 201, 202, 203, may represent applications associated with different respective devices. Alternatively, one or more of the applications 200 may be associated with a common device. For example, external applications 201, 202 may represent two different applications operable on a common computing/communication device, such as a mobile phone, computer, PDA, etc. Further, an external application 201 may also include other vertical applications 204 representing applications at various levels. Thus, such external applications 200 may include web servers, e-mail and other messaging (e.g., SMS, MMS, etc.) applications, workgroup applications, calendar and/or contact applications, and the like. Any type of external application may be used in connection with the present invention.

The illustrated communication device 206 includes computing architecture such as a processor (not shown) controlled at least in part by software. A local clipboard 212 may store information posted to it by the communication device 206 itself, or posted to it by external applications by way of the clipboard service 214 as described more fully below. The local clipboard 212 is typically, but not necessarily, included in an Operating System (OS) 216 of the device 206. One or more applications 218 may run on top of the OS 216.

In accordance with the invention, the clipboard service 214 is exposed to the external applications 200 over the network(s) 208. Recognizing the exposed clipboard service 214, an external application 200 such as application 201 may issue one or more service requests 220 towards the clipboard service 214. The clipboard service 214 manages acceptance of such requests 220, and if necessary may translate such requests 220 to native calls to the clipboard Application Programming Interface (API) 222. For example, the request 220 from external application 201 may be to “paste” information-1 (INFO-1) 224A from the local clipboard 212 of device 206 to a current entry field of external application 201, as depicted by the transfer of INFO-1 224B.

In a similar manner, an external application 200 may cut, copy, or otherwise post information to the clipboard 212 of device 206 via the clipboard service 214. Posting information to the clipboard 212 by an external application 200 may be beneficial in a variety of use scenarios. For example, it is possible that certain vertical applications 204 associated with a particular device are not compatible with local clipboard functionality, i.e., copying information to a local clipboard of the device operating application 201 may not be available for pasting into a vertical application 204. In such a case, the information can be posted to the local clipboard 212 of the device 206 and pasted into a vertical application 204. As another example, a user may have access to multiple devices, and may post information from a first application on a first device to the clipboard 212 via the clipboard service 214, and later “paste” that information into a second application on a second device. Another example involves copying certain information from an external application 201 to the clipboard 212 via the clipboard service 214 to allow other users of other devices to retrieve the information via the clipboard service 214.

One particularly beneficial use of the clipboard service 214 is to allow the device 206 to copy local information to the local clipboard 212 for use by any of the external applications 200. For example, an application 218 operating on the communication device 206 may post INFO-2 226 to the clipboard 212, and by way of the clipboard service 214 make that INFO-2 226 available to any one or more of the external applications 200. As a more particular example, the application 218 may represent a web server that hosts a web site, Wireless Application Protocol (WAP) site, or other similar site. A first external application 201 may represent a browser application that is accessing the web site, where certain information INFO-2 226 is posted by the application 218 to the clipboard 212. The application 201, or any other application 204 available on the device may then paste the INFO-2 226 into an appropriate field of the application 201/204.

FIG. 3 is a flow diagram generally illustrating a manner of communicating information over a network in accordance with one embodiment of the invention. The local clipboard functionality of a computing device is exposed 300 to one or more external applications over a network. Access to the exposed local clipboard by the external application(s) is enabled 302. Transfer of the information between the local clipboard of the computing device and the external application(s) is facilitated 304 by the clipboard service.

In accordance with one embodiment of the invention, the clipboard service is implemented as a “web service.” A web service generally refers to a network-based (particularly Internet-based) modular application that performs a specific task(s) and generally conforms to a particular technical format. Currently, web services are represented by a stack of emerging standards that describe a service-oriented, component-based application architecture, collectively providing a distributed computing paradigm having a particular focus on delivering services across the Internet. Generally, web services are self-contained modular applications that can be published in a ready-to-use format, located, and invoked across the World Wide Web. When a web service is deployed, other applications and web services can locate and invoke the deployed service.

Advantageously, web services are currently accessed via ubiquitous Web protocols and data formats, such as Hypertext Transfer Protocol (HTTP) and Extensible Markup Language (XML). Thus, at present, an exemplary Web service platform is XML plus HTTP. XML is a text-based markup language that is currently used extensively for data interchange on the Web. As with HTML, data is identified using tags, which are collectively known as “markup”. XML tags identify the data, and act as a field name in the program. XML is a language that allows complex interactions between clients and services, as well as between components of a composite service, to be expressed. HTTP is an application protocol, and more particularly is a set of rules for exchanging files (text, graphic images, sound, video, and other multimedia files) on a network such as the World Wide Web. While the examples set forth herein may generally be described in connection with XML and HTTP, it should be recognized that this is for illustrative purposes, and current and future types of protocols and data formats may also be employed.

More specifically, web services represent a collection of several related technologies, and involve connections between at least two applications, such as a remote procedure call (RPC), in which queries and responses are exchanged in XML over HTTP. Web service technologies may be defined in terms of various technology layers. The core layers include a transport layer, such as HTTP, SMTP, FTP, etc., in which XML messages may be communicated. An XML messaging layer, implementing a protocol such as Simple Object Access Protocol (SOAP), also represents a core layer of web services. SOAP is a protocol specification that defines a uniform manner of passing XML-encoded data, as well as defines a manner to perform RPCs using HTTP as the underlying communication protocol.

Higher level layers of the web services stack include a service discovery layer, which may include technologies such as the Web Services Description Language (WSDL) and Universal Description, Discovery, and Integration (UDDI). WSDL is an XML-based description defining how to connect to a particular web service, and thus indicates how service providers are to describe the basic format of web service requests over different protocols or encodings. It is used to describe what a web service can do, where it resides, and how to invoke it. UDDI provides a manner in which clients can dynamically locate other web services. It represents a set of protocols and a public directory for the registration and real-time location of web services and other business processes. UDDI provides a manner for web service providers to register themselves, and provides a manner for an application to find, connect to, and interact with a particular web service. Another related registry is currently described as part of the Liberty Alliance Project, known as the “Liberty ID-WSF Discovery Service Specification,” (Ver. 1.0-08). Where UDDI is primarily used to allow UDDI clients to locate services that offer a particular function, the Liberty Discovery Service Specification provides a somewhat different discovery paradigm. This Specification allows a Discovery Service (DS) client to provide the DS a resource identifier (e.g., “ResourceIdentifier”) associated with a user, and asks for pointers to services of a particular type and for that particular resource identifier.

Other higher level layers of the web services stack may include a workflow layer. A workflow layer may include a technology such as the Web Services Flow Language (WSFL). WSFL is an XML language for the description of web services compositions. It allows for recursive compositions of web services within others to create more complex features built upon existing web services.

The aforementioned and other technologies, protocols, data formats, and the like may be used in employing a clipboard web service in accordance with the present invention. However, these known technologies are referenced in order to provide exemplary technologies currently available in the development and use of web services. The invention thus may utilize these known technologies, but is also applicable to other existing and/or future technologies, as will be readily apparent to those skilled in the art from an understanding of the description provided herein.

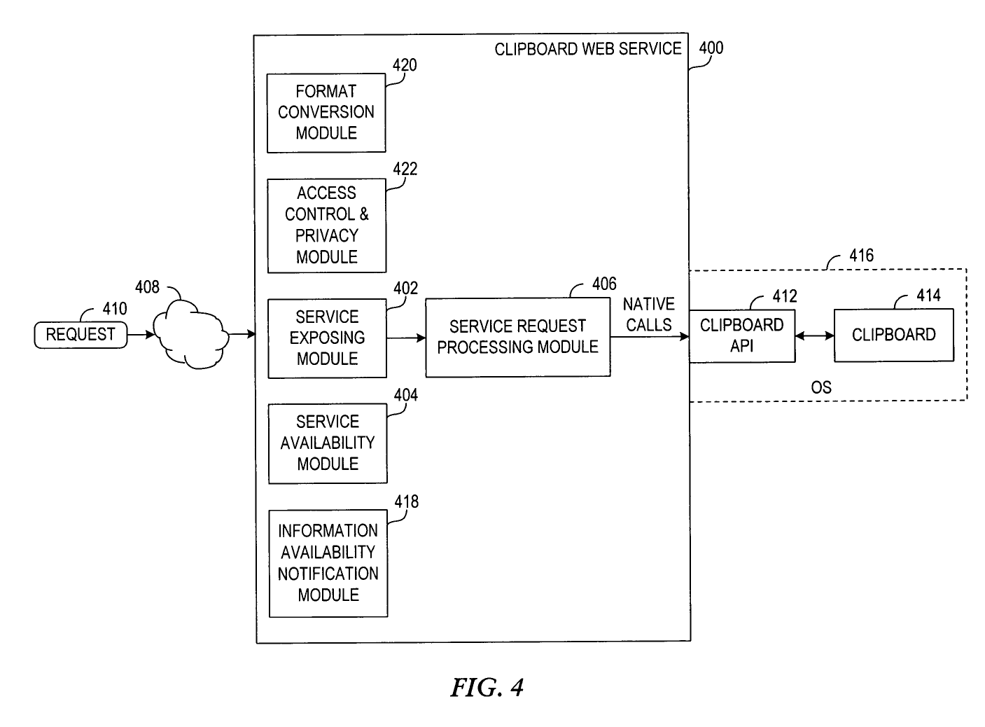

FIG. 4 is a block diagram of an implementation of a clipboard service according to one embodiment of the present invention, where the clipboard service is implemented as a web service. The clipboard web service 400 includes a service exposing module 402, which provides a manner for exposing the service. In accordance with the invention, the clipboard service is made available to the client requesting its use, which is often referred to as “exposing” the service. Exposing a web service therefore generally refers to making the service available by service providers to service requestors. Exposing the clipboard service of the present invention may be performed in any known manner, and a variety of manners of exposing a web service are known in the art. For example, exposing a web service may involve publishing a description of the web service. From the web service protocol stack point of view, this is often considered as the service description layer. The service description layer is responsible for describing the public interface to a specific web service(s), and is generally handled via the Web Service Description Language (WSDL), but may be handled via other analogous languages. Thus, a web service may be exposed by publishing a description of the web service, where the description includes the service's WSDL description and XML schemas referenced by the service description. While web service descriptions may be published on a private or public registry using an interface such as UDDI, they need not be, as such service descriptions may be published on the Web tier of the application or at some other known location.

In one embodiment of the invention, a manner of exposing the clipboard web service is accomplished using an exposing method where the clipboard service is made available even though the corresponding device is not addressable or is otherwise unable to be reached. For example, while a device hosting the clipboard service may be addressable in some sense, it may not be directly accessible by a known network address. More particularly, the device hosting the service may be addressable through intermediary network entities such as through the use of the Session Initiation Protocol (SIP), but may not otherwise be directly addressable using a known network address. Further, the device hosting the clipboard service may not offer an underlying protocol that is currently listening (e.g., the device hosting the clipboard service is an HTTP client but not an HTTP server). For these and other reasons, the clipboard service may not be directly addressable or may otherwise be unable to be reached.

However, in accordance with various embodiments of the invention, the clipboard service may be exposed to external applications even under such circumstances. This may be accomplished using, for example, SIP techniques, reverse HTTP bindings, or others. For example, the local clipboard may be exposed by establishing a session using SIP. As another example, the device associated with the clipboard web service may include an HTTP client, where the local clipboard is exposed via the HTTP client using SOAP. This is referred to as a reverse HTTP binding according to the “Liberty Reverse HTTP Binding 1.0” by the Liberty Alliance Project. These and other manners of exposing the web service may be employed in accordance with the present invention.

The clipboard web service 400 also includes a method for informing external applications of the availability of the service, as depicted by the service availability module 404. This can be accomplished in a variety of ways. For example, this may be accomplished using a public or private registry and using an interface such as UDDI. In one embodiment of the invention, a registry such as the previously-described “Liberty ID-WSF Discovery Service Specification” is utilized. Such a registry allows a Discovery Service (DS) client to provide the DS with a resource identifier (e.g., “ResourceIdentifier”) that is associated with a particular user/entity, and request pointers to services of a particular type for that particular resource identifier (and consequently, for that particular user). In this manner, an application may ask a DS where a particular clipboard service of a particular user/entity can be found. Use of the Liberty Discovery Service or analogous discovery service in connection with the present invention therefore allows for a significant degree of specificity in clipboard service transactions. For example, a user can browse to a first web site which in turn locates the DS of the user and asks that DS for the clipboard service of that user. The first web site places information on the clipboard associated with the user's clipboard service. When the user then browses to a second web site, the second web site locates the DS of the same user, and asks that DS for the clipboard service of that user. The second web site can then copy the information from the user's clipboard service. Accordingly, the use of a DS allows the second web site to find the clipboard service of the particular user/entity where the information was stored, thereby allowing the information to be retrieved from the appropriate clipboard. Other representative manners in which the availability of the service may be made known to external applications include, but are not limited to, publishing the service description via a web/WAP (or other) site to which the user may access or is already accessing, a PAOS implementation, by way of an entry in a device profile, as well as other known manners.

The actual service implementation may be performed using the service request processing module 406. The service request processing module 406 accepts service requests from the service exposing module 402 as received over the network 408, such as service request 410 from an external application. The service request processing module 406 may translate such requests 410 to native calls to the clipboard API 412, which provides the interface between the clipboard web service 400 and the clipboard 414. Often, a clipboard 414 is provided as part of the OS 416, but need not be. Where the clipboard 414 is provided as part of the OS 416, the clipboard API 412 operates in a known manner for interfacing the clipboard 414 with an application, i.e., the clipboard web service 400 in the illustrated example.

The clipboard web service 400 embodiment of FIG. 4 also includes a function that notifies the service-requesting user that information is available on the shared clipboard 414. In a traditional clipboard implementation, the clipboard only contains items that were “copied” to it by user action. In accordance with the invention, external applications can place information on the clipboard, and because an application on the device to which the clipboard web service 400 is associated may place information on the clipboard, the remote user/requester should be made aware of the possibility to copy items from the clipboard 414 into local applications. The information availability notification module 418 is used for such purposes. For example, a user may connect to a web site to utilize a web server application on a computing device to which the clipboard web service 400 is also provided. The web site could request the clipboard web service 400 to place certain information on its local clipboard 414. The information availability notification module 418 may, for example, indicate on one of its pages that it succeeded in placing the information on the local clipboard 414, or the information availability notification module 418 may instead (or additionally) notify the user of the presence of the new information on the clipboard 414 using any desired or known notification methodology.

In one embodiment of the invention, the clipboard web service 400 optionally includes a format conversion module 420. The module 420 can perform format conversions, such as XML-to-plain text conversions, vCard to XML conversions, and the like. For example, assume a contact address stored on the clipboard 414 is to be “pasted” by the external application, and the clipboard 414 stores the contact address in accordance with vCard standards. If the external application requesting the information does not utilize the vCard format, the contact address may be transferred using a platform-independent protocol such as XML. The format conversion module 420 may be used to convert the contact address from the vCard format to XML data to facilitate the desired format at the requesting external application. As another example, certain text could be converted from rich text format (RTF) to plain text for insertion into an external e-mail application that does not support RTF. The format conversion module 420 can be configured in any manner known in the art to provide the desired format conversions.

Another embodiment of the clipboard web service 400 optionally includes an access control/privacy module 422. Before the clipboard web service 400 honors a request 410 from an external application, it may check if that external application has permission to read or write the clipboard 414. The clipboard web service 400 may include its own set of access control rules, and/or may call upon another module to check for such permissions. Such a module, or the clipboard service 400 itself, may also prompt the user for permissions, or utilize other known authorization mechanisms.

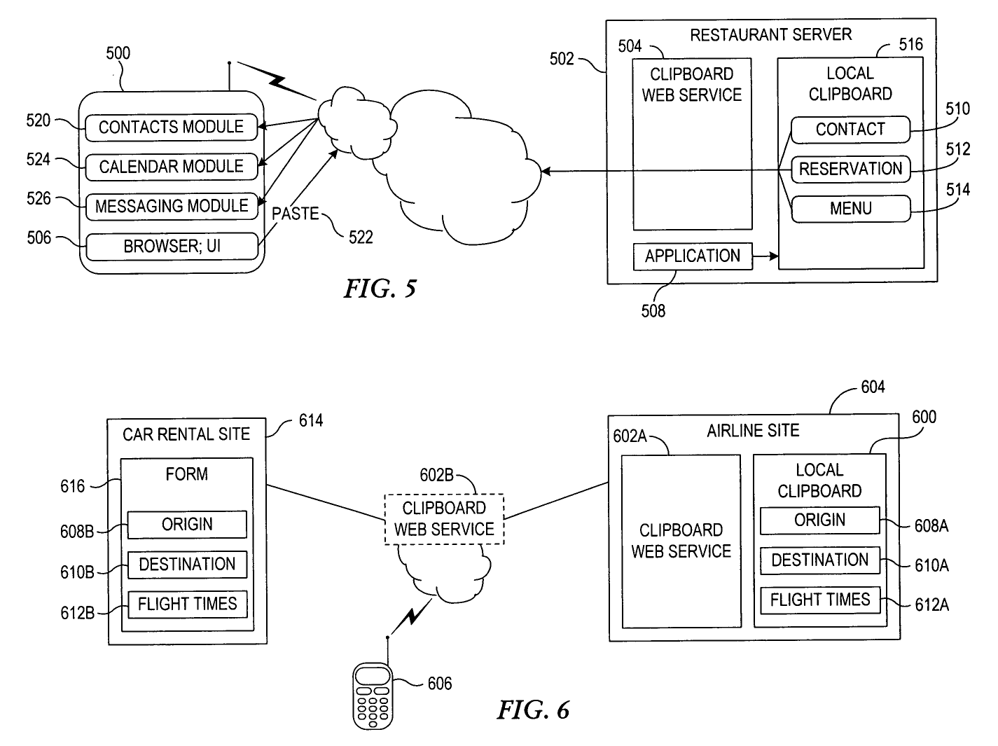

FIG. 5 is a block diagram illustrating a representative manner in which the principles of the present invention may be employed. While the present invention is applicable where the external application and the clipboard service are provided via either wireless or landline devices, the illustrated embodiment of FIG. 5 involves a wireless device 500 which includes the external application, and a server 502 hosting a web site where the server implements a clipboard web service 504 in accordance with the invention. In this example, the user of the mobile device 500 instructs the device 500 to connect to a web site hosted by the server 502, where the web site 502 is associated with a restaurant. Using a local browser application and any appropriate user interface (UI) mechanisms as illustrated at module 506, the user may, for example, make a dinner reservation. The server application 508 represents the web site application to which the user communicates to make such dinner reservation.

In connection with making the dinner reservation, the web site (e.g., application 508) may request that the clipboard service 504 place the restaurant contact information 510, reservation time 512 (e.g., a meeting object), as well as the menu 514 on the local clipboard 516. The web site may, for example, indicate on one of its pages that it succeeded in placing such information on its local clipboard 516, or other notification techniques may be used such as sending a notification to the user regarding the presence of new information of a certain type on the clipboard 516, or other notification techniques. The user may then open a local contact application, shown as the contacts module 520 in FIG. 5, and “paste” 522 the contact information 510 into the contact application. Another example is for the user to paste the contact information into a route planning module, which takes the contact address and maps the location. The user may also open a local calendar program depicted as the calendar module 524, and may paste 522 the reservation details 512. The user may further open a messaging or e-mail application shown as messaging module 526, and paste 522 the menu 514 into a new message for transport to another user.

FIG. 6 is a block diagram illustrating another use case example employing the principles of the present invention. In this example, a local clipboard 600 and clipboard service 602A are associated with a system hosting an airline site 604. The user, represented by mobile device 606, makes a flight reservation via the airline site 604. The site 604 copies the origin 608A and destination 610A locations, as well as the flight times 612A, to the local clipboard 600. In one embodiment, the origin/destination and flight times may be copied onto the clipboard 600 as contact and meeting objects respectively. The user 606 subsequently visits a car rental site 614 that may include an electronic form 616 with various form fields in which data is to be entered. The user 606 may copy the origin 608B, destination 610B, and flight time 612B information into the form 616 from the local clipboard 600 as facilitated by the clipboard web service 602A. It should be noted that while the clipboard service 602A may be co-located with the device where the local clipboard 600 resides, it may alternatively be hosted by another server on the network as indicated by clipboard web service 602B.

In accordance with one embodiment of the invention, the local clipboard implementation supports multiple formats per item. For example, the contact information may be available in multiple formats, such as plain text, vCard, etc. A format conversion module, such as the format conversion module 420 shown in FIG. 4, may be used to copy multiple formats of an item onto the clipboard, or alternatively a single format may be stored on the local clipboard and a format conversion module utilized to change the format depending on the format desired by the requesting external application or user. Further, one embodiment of the invention supports multiple items on the local clipboard, such as depicted on local clipboard 600 of FIG. 6 where multiple items 608A, 610A, 612A or more may be placed on the local clipboard 600. In this manner, a user can paste the appropriate information at the appropriate location and in connection with the appropriate external application. This may be accomplished in various ways, such as providing an indication on the supplying web site of the particular item to be pasted to the external application, or by providing descriptive indicia for each clipboard item on a selectable window to the user, etc.

In one embodiment of the invention, the external applications may mark items with freely chosen “keywords” so that other applications can differentiate items based upon keywords. For example, a “contact” or “address” item may be marked with a keyword such as “destination” that differentiates it from an address that is marked as “origin.” Using the example of FIG. 6, two items may be presented as “contact” items, but may be associated with keywords “origin” and “destination” to distinguish the contact items for the origin 608B and destination 610B fields. Such keywords can therefore provide for such differentiation for use within a particular application or between different applications.

Keywords may also be used in other manners, such as included in a request to a clipboard service, and/or when the external application(s) writes data to the clipboard service. In the case of using keywords in a request to a clipboard service, an external application may, for example, request information from the clipboard service in a first format such as a vCard format, along with a keyword such as “destination.” In one embodiment, a request may have a number of optional arguments, such as the type of data (e.g., a “meeting” object), one or more formats (e.g., MIME types), and one or more keywords. When a request is sent to the clipboard service with any one or more of these representative arguments, the clipboard service can respond with the requested clipboard item(s) annotated with any one or more of these arguments. Therefore, in the case of keywords, the request may include one or more keywords, and the clipboard service may respond with the requested clipboard information together with the associated keywords that can be used by the requesting external application. Furthermore, such keywords may be used by the external application when writing to the clipboard service so that the data stored via the clipboard service is annotated with the desired keyword(s). In this manner, a subsequent request to “paste” or otherwise retrieve the stored information can be provided together with the associated keyword(s).

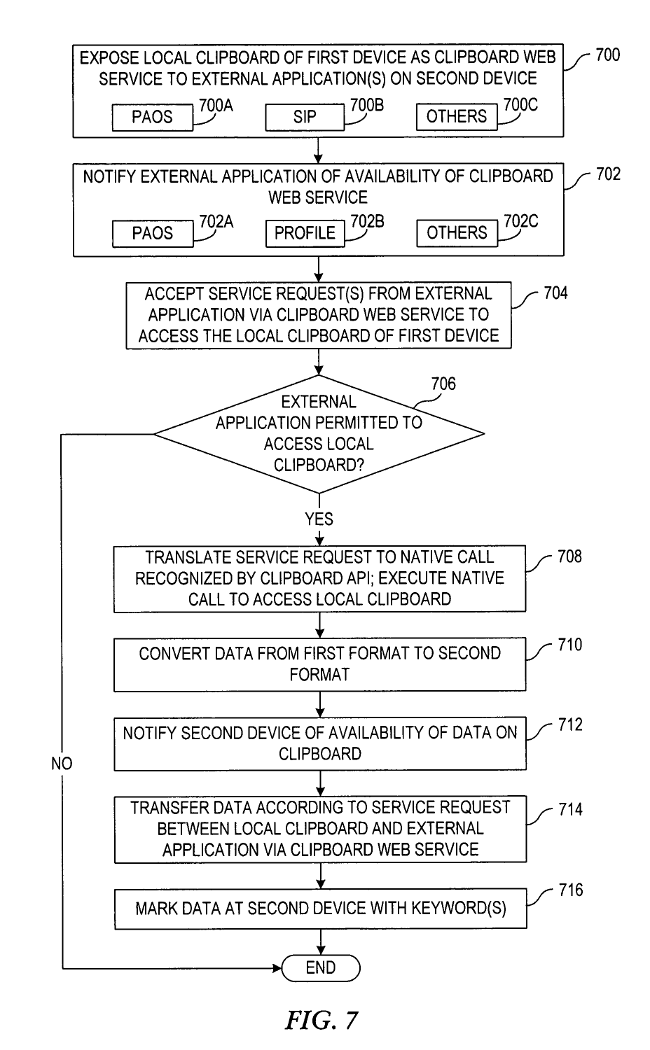

FIG. 7 is a flow diagram illustrating various embodiments of a manner for transferring data between first and second devices, where the clipboard service is implemented as a web service. In one embodiment of the invention, the method includes exposing 700 the local clipboard of the first device as a clipboard web service to an external application(s) operating on the second device, and the external application is notified 702 of the availability of the clipboard web service. Service requests are accepted 704 from the external application(s) via the clipboard web service to access the local clipboard of the first device. The data is transferred 714 between the devices by way of the clipboard web service and according to the service request. For example, a service request to copy information to the local clipboard from the external application will result in a transfer from the external application towards the web service, where a service request to paste information at the external application will result in a transfer of the data from the web service towards the external application.

The embodiment of FIG. 7 may include various features or options. For example, in one embodiment, exposing 700 the local clipboard as a web service may be implemented using “PAOS,” 700A which is an informal abbreviation for the “Liberty Reverse HTTP Binding 1.0” by the Liberty Alliance Project. The signaling protocol SIP 700B may also be used to expose the service, as well as other 700C exposing techniques known in the art. In another embodiment, notifying 702 the external application of the availability of the clipboard web service may involve use of PAOS 702A, entry in a device profile 702B of the second device, or other 702C notification techniques known in the art.

In other particular embodiments, it may be determined 706 whether the external application is permitted to access the local clipboard of the first device. In this manner, access to the local clipboard may be controlled by determining whether the external application has permission to read or write the local clipboard. Various manners of controlling such access may be employed, such as performing a call function to another module to identify whether such permission exists, and/or prompting the user of the second device for any such permissions. In accordance with this embodiment, the external application will be allowed to continue with reading/writing the local clipboard of the first device if such permission exists.

Another optional embodiment involves translating 708 the service request to a native call(s) that is recognized by the clipboard API. When the service request has been translated, the native call can be executed to access the local clipboard. In another embodiment, the data may be converted 710 from a first format to a second format, or even additional formats if desired. For example, the data may be converted from vCard format to plain text. Another embodiment involves notifying 712 the second device of the availability of the data on the local clipboard of the first device. The data may then be transferred 714, whether data is being copied to or from the local clipboard. In accordance with another embodiment, the data may be marked 716 with keywords, as previously described.

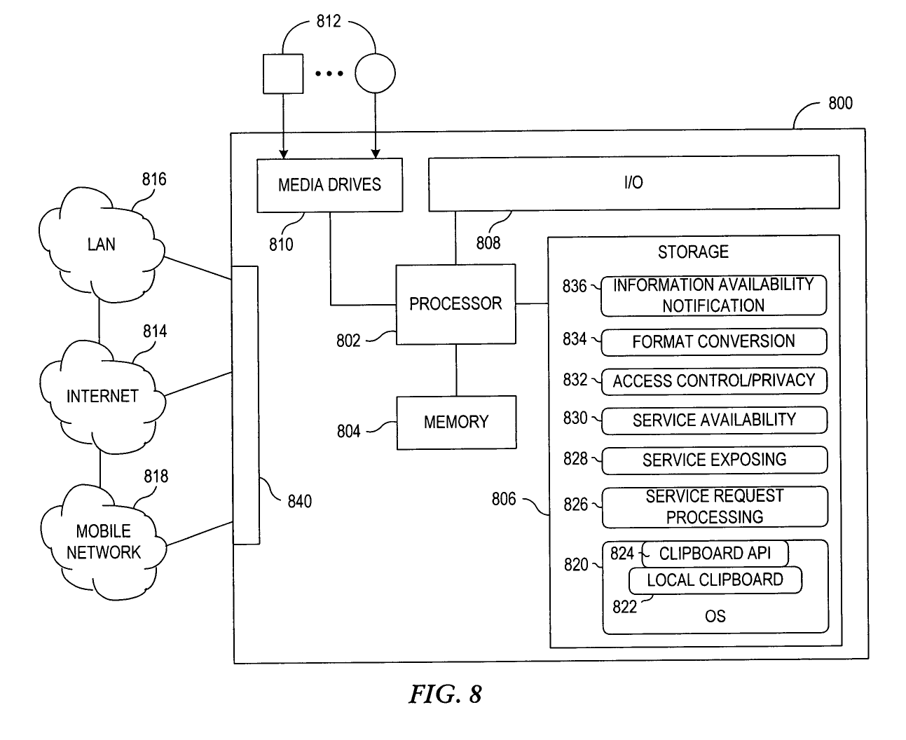

FIG. 8 is a block diagram of a representative computing architecture 800 capable of carrying out operations in accordance with the invention. Hardware, firmware, software or a combination thereof may be used to perform the clipboard service functions and operations in accordance with the invention. The embodiment illustrated in FIG. 8 may represent any device from which the clipboard service is to be provided in accordance with the invention.

The representative computing arrangement suitable for performing the clipboard service functions includes a central processor 802, which may be coupled to memory 804 and storage 806. The processor 802 carries out a variety of standard computing functions as is known in the art, as dictated by software and/or firmware instructions. The storage 806 may represent firmware, hard-drive storage, etc. The storage 806 may also represent other types of storage media to store programs, such as programmable ROM (PROM), erasable PROM (EPROM), etc. The processor 802 may communicate with other internal and external components through input/output (I/O) circuitry 808. The device 800 may also include one or more media drive devices 810, including hard and floppy disk drives, CD-ROM drives, DVD drives, and other hardware capable of reading and/or storing information. Where the device 800 represents a mobile device such as a mobile phone, PDA, or the like, other media such as removable memory devices may also be utilized. In one embodiment, software for carrying out the operations in accordance with the present invention may be stored and distributed on CD-ROM, diskette, removable memory, or other form of media capable of portably storing information, as represented by media devices 812. These storage media may be inserted into, and read by, the media drive devices 810. Such software may also be transmitted to the device 800 via data signals, such as being downloaded electronically via a network, such as the Internet 814, Local Area Network (LAN) 816, mobile network 818, or any combination thereof.

In accordance with one embodiment of the invention, the storage 806, memory 804, and/or media devices 812 store the various programs and data used in connection with the present invention. In the illustrated embodiment of FIG. 8, the storage 806 is shown storing the various program modules, operable in connection with the processor 802. For example, the illustrated embodiment depicts an operating system 820, associated local clipboard 822 and clipboard API 824. The program modules of the illustrated embodiment also include the service request processing module 826 and service exposing module 828. The program modules may also include, in some embodiments, any one or more of a service availability module 830, access control and privacy module 832, format conversion module 834, and information availability notification module 836. The functionality associated with each of these modules has been previously described, such as in connection with the description of FIG. 4. It should be noted that many of the program modules depicted in FIG. 8 represent optional features. It should also be noted that the computing architecture 800 is generally applicable to landline or wireless devices, and variations thereof will be readily apparent to those skilled in the art from the description provided herein. For example, the transceiver 840 may represent a wireless transceiver where the device 800 represents a mobile device that communicates over-the-air (OTA); or a transceiver available at a network interface mechanism for landline computing systems.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

1. A method for communicating information over a network, comprising:
exposing a local clipboard of a computing device as a service to at least one external application over the network;
receiving a transfer indication from the external application that a transfer of information between the exposed local clipboard of the computing device and the external application is requested; and
facilitating the transfer of information between the local clipboard of the computing device and the external application in response to the transfer indication.

2. The method of claim 1, wherein exposing the local clipboard of the computing device as a service comprises exposing the local clipboard as a web service to the one or more external applications over the network.

3. The method of claim 1, wherein receiving a transfer indication comprises receiving a request to copy information from the local clipboard to the external application.

4. The method of claim 1, wherein receiving a transfer indication comprises receiving a request to copy information from the external application to the local clipboard of the computing device.

5. The method of claim 1, wherein receiving a transfer indication comprises recognizing selection of a link presented to a browser application executing on a device associated with the external application, and receiving the transfer indication associated with the selected link.

6. The method of claim 1, further comprising providing a notification to the external application that information was posted to the local clipboard by the computing device.

7. The method of claim 6, wherein providing a notification to the external application comprises sending a message to the external application indicating that the information was posted to the local clipboard by the computing device.

8. The method of claim 6, wherein providing a notification to the external application comprises presenting information on a network site available to the external application, indicating that the information was posted to the local clipboard by the computing device.

9. The method of claim 1, wherein facilitating a transfer of the information between the local clipboard and the external application comprises transmitting the information from the local clipboard to the external application over the network.

10. The method of claim 1, wherein facilitating a transfer of the information between the local clipboard and the external application comprises receiving the information from the external application and storing the information on the local clipboard.

11. The method of claim 1, wherein the computing device comprises a Hypertext Transfer Protocol (HTTP) client, and wherein exposing the local clipboard comprises exposing the local clipboard via the HTTP client using a Simple Object Access Protocol (SOAP).

12. A method for transferring data between first and second devices over a network, comprising:
exposing a local clipboard of the first device as a clipboard web service to at least one external application operating on the second device;
notifying the external application of the availability of the clipboard web service;
accepting service requests from the external application via the clipboard web service to access the local clipboard of the first device; and
transferring the data in accordance with the service request between the local clipboard and the external application via the clipboard web service.

13. The method of claim 12, further comprising notifying the second device of the availability of data on the clipboard.

14. The method of claim 12, further comprising translating the service request to a native call recognized by a clipboard API and executing the native call to access the local clipboard of the first device.

15. The method of claim 12, further comprising converting the data from a first format to at least a second format prior to transferring the data.

16. The method of claim 12, further comprising controlling access of the external application to the local clipboard.

17. The method of claim 16, wherein controlling access comprises determining whether the external application has permission to read or write the local clipboard.

18. The method of claim 17, wherein determining whether the external application has permission to read or write the local clipboard comprises accessing local access control rules.

19. The method of claim 17, wherein determining whether the external application has permission to read or write the local clipboard comprises performing a call function to another module to identify whether such permission exists.

20. The method of claim 17, wherein determining whether the external application has permission to read or write the local clipboard comprises prompting the external application for permissions.

21. The method of claim 12, wherein the first device comprises a Hypertext Transfer Protocol (HTTP) client, and wherein exposing the local clipboard comprises exposing the local clipboard via the HTTP client using a Simple Object Access Protocol (SOAP).

22. The method of claim 12, wherein exposing the local clipboard comprises exposing the local clipboard by establishing a session using a Session Initiation Protocol (SIP).

23. The method of claim 12, wherein the first device comprises a Hypertext Transfer Protocol (HTTP) client, and wherein notifying the external application of the availability of the clipboard web service comprises notifying the external application via the HTTP client using a Simple Object Access Protocol (SOAP).

24. The method of claim 12, wherein notifying the external application of the availability of the clipboard web service comprises providing a notification entry in a device profile of the second device.

25. The method of claim 12, further comprising marking the data at the external application with at least one keyword.

26. The method of claim 25, further comprising differentiating the marked data from other data based on at least the keyword.

27. The method of claim 12, wherein accepting service requests from the external application comprises accepting service requests having one or more request arguments associated therewith, wherein the one or more arguments comprise any one or more of a data type, a format type, and a keyword.

28. The method of claim 12, wherein accepting service requests from the external application comprises accepting service requests having one or more keywords associated therewith.

29. The method of claim 28, wherein the service request comprises a service request to retrieve data from the local clipboard of the first device, and wherein transferring the data in accordance with the service request comprises transferring the data and the one or more keywords associated with the data from the local clipboard to the external application via the clipboard web service.

30. The method of claim 28, wherein the service request comprises a service request to write data to the local clipboard of the first device, and wherein transferring the data in accordance with the service request comprises transferring the data and the one or more keywords associated with the data from the external application to the local clipboard via the clipboard web service.

31. The method of claim 12, wherein the service request to access the local clipboard of the first device comprises a service request to write data from the external application to the local clipboard.

32. The method of claim 12, wherein the service request to access the local clipboard of the first device comprises a service request to read data from the local clipboard to the external application.

33. A computer-readable medium having instructions stored thereon which are executable by a computer system for communicating information over a network by performing steps comprising:
exposing a local clipboard of a computing device as a service to at least one external application over the network;
receiving a transfer indication from the external application that a transfer of information between the exposed local clipboard of the computing device and the external application is requested; and
facilitating the transfer of information between the local clipboard of the computing device and the external application in response to the transfer indication.

34. The method of claim 33, wherein the instructions for exposing the local clipboard to at least one external application comprises instructions for exposing the local clipboard as a web service to the one or more external applications over the network.

35. A network entity operable on a network, comprising:
a local clipboard for storing data;
a clipboard service exposing module for exposing the local clipboard as a service towards external applications having access to the network entity via the network;
a service request processing module coupled to the clipboard service exposing module to receive service requests provided by the external applications; and
a transceiver to transfer the data between the local clipboard and the external applications as directed by the service requests.

36. The network entity as in claim 35, further comprising a clipboard Application Programming Interface (API) coupled between the service request processing module and the local clipboard of the network entity.

37. The network entity as in claim 35, further comprising a data availability notification module to notify the external applications that data has been posted to the local clipboard that is available to the external applications.

38. The network entity as in claim 35, wherein the network entity comprises a server operable on the network.

39. The network entity as in claim 35, wherein the network entity comprises a mobile computing device coupled to the network over-the-air (OTA).

40. A computing device operable on a network, comprising:
a local clipboard for storing data;
a processor configured to expose the local clipboard as a service towards external applications having access to the computing device via the network, and to receive service requests provided by the external applications; and
means for transferring the data between the local clipboard and the external applications as directed by the service requests.

41. A system for communicating data over a network, comprising:
a first network entity hosting at least a first application;
a second network entity including a local clipboard for locally storing data, wherein the second network entity further comprises:
a processor configured to expose the local clipboard as a service towards the first application hosted by the first network entity, and to receive service requests provided by the first application; and
a transceiver to transfer the data between the local clipboard and the first application as directed by the service requests.
